(19) United States
(12) Patent Application Publication
(10) Pub. No.: US 2024/0161156 A1
(43) Pub. Date: May 16, 2024

(54) METHOD AND SYSTEM FOR CHAUFFEUR RECOMMENDATION SERVICE

(71) Applicant: MOVV Inc., Seoul (KR)

(72) Inventor: Min-Suk CHOI, Seoul (KR)

(21) Appl. No.: 17/992,698

(22) Filed: Nov. 22, 2022

(30) Foreign Application Priority Data
Nov. 15, 2022 (KR) 10-2022-0152789

(51) Int. Cl. G06Q 30/02; G06Q 10/06; G06Q 50/30

(52) U.S. Cl. CPC G06Q 30/0282; G06Q 10/06393; G06Q 50/30

(57) ABSTRACT

Provided is a method and a system for a chauffeur recommendation service by which a chauffeur preference property of a current user is determined based on a correlation between a plurality of existing users with a history of using a chauffeur service and the current user, and at least one chauffeur matching the chauffeur preference property of the current user is selected and recommended among a plurality of chauffeurs, and accordingly, a user may use a chauffeur service provided by a chauffeur matching his/her personal property.

### CROSS-REFERENCE TO RELATED APPLICATION

This application is based on and claims priority under 35 U.S.C. § 119 to Korean Patent Application No. 10-2022-0152789, filed on Nov. 15, 2022, in the Korean Intellectual Property Office, the disclosure of which is incorporated by reference herein in its entirety.

### BACKGROUND

### 1. Field

The present disclosure relates to a method and a system for a service for recommending at least one of a plurality of chauffeurs to a user of a chauffeur service.

### 2. Description of the Related Art

In recent years, there have been an increasing number of airlines providing a reservation passenger of an airplane with a chauffeur service from a passenger's residence to an airport before the passenger boards an airplane. After the flight arrives, the chauffeur service is sometimes provided from the airport to a hotel. In addition to this, the chauffeur service is provided for a specific place, such as a golf course. A user may search for information on multiple vehicles to select a vehicle for providing the desired chauffeur service, but a chauffeur is randomly assigned by the company providing the chauffeur service. The number of complaints on chauffeurs from users are increased.

### SUMMARY

An object of the present disclosure is to provide a method and a system for a chauffeur recommendation service that may improve user satisfaction on a chauffeur service by allowing a user to move from a departure to a destination by using a vehicle driven by a chauffeur matching to his/her personal property. The present disclosure is not limited to the technical objects described above, and other technical objects may be derived from the following description.

According to an aspect of the present disclosure, a method for a chauffeur recommendation service includes receiving, from a current user who wants to use a chauffeur service, an input of a departure and a destination of a route for the current user to move, determining a chauffeur preference property of the current user based on a correlation between a plurality of existing users with a history of using the chauffeur service and the current user, selecting at least one chauffeur matching the determined chauffeur preference property of the current user from among a plurality of chauffeurs available for the input departure and the input destination, and recommending the selected at least one chauffeur to the current user.

In the determining of the chauffeur preference property of the current user, the chauffeur preference property of the current user may be determined from a chauffeur preference property of each of the plurality of existing users based on a correlation between personal characteristic information of each of the plurality of existing users and personal characteristic information of the current user.

The personal characteristic information may include time required to completely input a departure and a destination of a route on which and each of a plurality of users including the plurality of existing users and the current user wants to move, and a number of modifications during the inputting of the departure and the destination by each of the plurality of users, and in the determining of the chauffeur preference property of the current user, the chauffeur preference property of the current user may be determined based on a correlation between the plurality of existing users and the current user corresponding to similarity of the number of modifications during the inputting and the time required to completely input the departure and the destination between the plurality of existing users and the current user.

The personal characteristic information may include information on a country in which each user is located at a point in time when a departure and a destination to which a plurality of users including the plurality of existing users and the current user want to move are input, and in the determining of the chauffeur preference property of the current user, the chauffeur preference property of the current user may be determined based on a correlation between the plurality of existing users and the current user corresponding to similarity of the information of the country where each user is located at the point in time when the departure and the destination are input between the plurality of existing users and the current user.

In the determining of the chauffeur preference property of the current user, the chauffeur preference property of the current user may be determined by determining any one of a plurality of codes assigned to each of a plurality of chauffeur classification items for classifying the plurality of chauffeurs for each of a plurality of items based on a correlation between the plurality of existing users and the current user.

Any one code may be mapped for each of the plurality of chauffeur classification items to an ID of each of the plurality of chauffeur, and in the selecting of the at least one chauffeur, at least one chauffeur matching the chauffeur preference property of the current user may be selected by selecting at least one of the plurality of chauffeurs in an order of increasing number of matches between a plurality of codes determined for the plurality of chauffeur classification items and a plurality of codes mapped to IDs of the plurality of chauffeurs.

In the selecting of the at least one chauffeur, the at least one chauffeur may be selected in an order of increasing weight of each chauffeur from among a plurality of chauffeurs having the same number of matches between the plurality of codes determined for the plurality of chauffeur classification items and a plurality of codes assigned to the plurality of chauffeurs.

The weight of each chauffeur may be determined based on a score of each chauffeur evaluated by the plurality of existing users.

The plurality of chauffeur classification items may include at least two items among a gender item for classifying the plurality of chauffeurs according to a gender of each chauffeur, an age group item for classifying the plurality of chauffeurs according to an age group of the each chauffeur, a language item for classifying the plurality of chauffeurs according to an available language of the each chauffeur, and a conversation style item for classifying the plurality of chauffeurs according to a conversation style of the each chauffeur.

In determining of the chauffeur preference property of the current user, data indicating the chauffeur preference property of the current user may be obtained from an artificial neural network by inputting personal characteristic information of the current user to the artificial neural network trained by using personal characteristic information of each of the plurality of existing users and data indicating a chauffeur preference property of each of the plurality of existing users, and the chauffeur preference property indicated by the obtained data is determined as the chauffeur preference property of the current user.

In the determining of the chauffeur preference property of the current user, any one of a plurality of codes assigned to each of a plurality of chauffeur classification items for classifying the plurality of chauffeurs for each of a plurality of items may be obtained as the data indicating the chauffeur preference property of the current user from the artificial neural network, and in the selecting of the at least one chauffeur, at least chauffeur matching the determined chauffeur preference property of the current user may be selected by selecting at least one of the plurality of chauffeurs in an order of increasing number of matches between a plurality of codes determined for the plurality of chauffeur classification items and a plurality of codes mapped to an ID of each of the plurality of chauffeurs.

In the determining of the chauffeur preference property of the current user, any one of the plurality of codes assigned to each of the plurality of chauffeur classification items for classifying the plurality of chauffeurs for each of the plurality of items may be obtained and an occurrence probability value of each of the plurality of codes obtained for the plurality of chauffeur classification items simultaneously is obtained from then artificial neural network, and in the selecting of the at least one chauffeur, the at least one chauffeur may be selected in an order of increasing occurrence probability value of at least one code obtained from the artificial neural network for the plurality of codes mapped to the identification of each of the plurality of chauffeurs from among a plurality of chauffeurs having a same number of matches between a plurality of codes determined for the plurality of chauffeur classification items and the plurality of codes mapped to the ID of each of the plurality of chauffeurs.

According to another aspect of the present disclosure, there is provided a computer-readable recording medium in which a program for causing a computer to execute the above-described method for a chauffeur recommendation service is recorded.

According to another aspect of the present disclosure, a system for a chauffeur recommendation service includes a user interface configured to receive, from a current user who wants to use a chauffeur service, an input of a departure and a destination of a route for the current user to move, a user analyzer configured to determine a chauffeur preference property of the current user based on a correlation between a plurality of existing users with a history of using the chauffeur service and the current user, and a chauffeur scheduler configured to select at least one chauffeur matching the determined chauffeur preference property of the current user from among a plurality of chauffeurs available for the input departure and the input destination, wherein the user interface displays recommendation of the selected at least one chauffeur to the current user.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a configuration diagram of a chauffeur service system according to an embodiment of the present disclosure;

FIG. 2 is a configuration diagram of a user terminal 1, a chauffeur terminal 2, and a server 3 illustrated in FIG. 1;

FIG. 3 is a flowchart of a method for a chauffeur recommendation service according to an embodiment of the present disclosure;

FIG. 4 is an example view of an information input screen of a chauffeur service application that is executed by the chauffeur terminal 2 illustrated in FIG. 1;

FIG. 5 is an example view of an information input screen of a chauffeur service application being executed by the user terminal 1 illustrated in FIG. 1;

FIG. 6 is a diagram illustrating an example of learning of an artificial neural network used in a user analyzer illustrated in FIG. 2;

FIG. 7 is a diagram illustrating an example of using an artificial neural network trained according to the example illustrated in FIG. 6; and

FIG. 8 is an example view of a chauffeur recommendation screen of a chauffeur service application being executed by the user terminal 1 illustrated in FIG. 1.

### DETAILED DESCRIPTION

Hereinafter, embodiments of the present disclosure will be described in detail with reference to the drawings. The embodiments of the present disclosure to be described below provides a method and a system for a chauffeur recommendation service that may improve user satisfaction on a chauffeur service by allowing a user to move from a departure to a destination by using a vehicle driven by a chauffeur matching to his/her personal property, and hereinafter, the method and the systems may also be briefly referred to respectively as a “chauffeur recommendation service method” and a “chauffeur recommendation service system”. The chauffeur service according to the present embodiment is a passenger transfer service by a vehicle accompanying a chauffeur, and the vehicle used for this may be a commercial vehicle, such as a rental car or may also be a private vehicle owned by a driver. Hereinafter, a vehicle used by a chauffeur service according to the present embodiment will be described to be limited to a commercial vehicle.

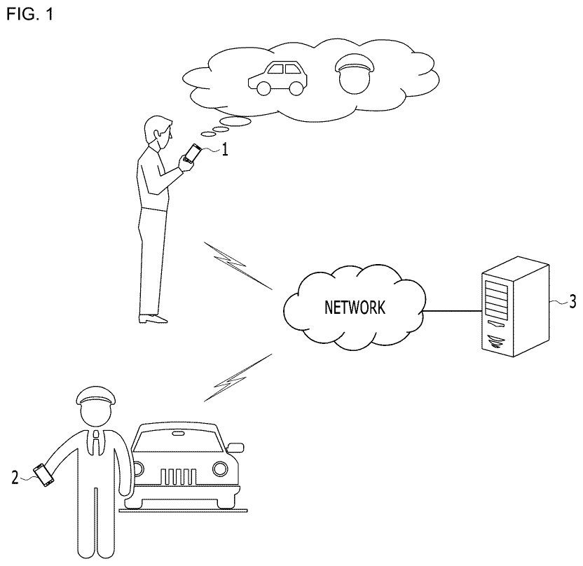

FIG. 1 is a configuration diagram of a chauffeur service system according to an embodiment of the present disclosure. Referring to FIG. 1, the chauffeur service system according to the present embodiment includes a user terminal 1, a chauffeur terminal 2, and a server 3. The user terminal 1 performs a chauffeur service method for allowing a user to use a chauffeur service according to the present embodiment from a user's aspect through a chauffeur service application. The chauffeur terminal 2 performs a chauffeur service method for allowing a chauffeur to use the chauffeur service according to the present embodiment from a chauffeur's aspect through the chauffeur service application. The chauffeur service application that is executed by the user terminal 1 is an application for interaction with a user as a passenger using the chauffeur service, and a chauffeur service application that is executed by the chauffeur terminal 2 is an application for interaction with a user as a chauffeur using the chauffeur service.

The server 3 performs the chauffeur service method for relaying the user terminal 1 and the chauffeur terminal 2 such that the chauffeur service method is performed by the user terminal 1 and the chauffeur service method is performed by the chauffeur terminal 2. The user terminal 1 and the chauffeur terminal 2 are small terminals, which may be carried by a user and a driver, such as smartphones, tablet personal computers (PCs), or notebook computers. The server 3 may be a high-performance large computer that may relay a chauffeur service of the present embodiment by being simultaneously connected to numerous user terminals 1 and driver terminals 2 and may be one physical computer or a set of a plurality of computers.

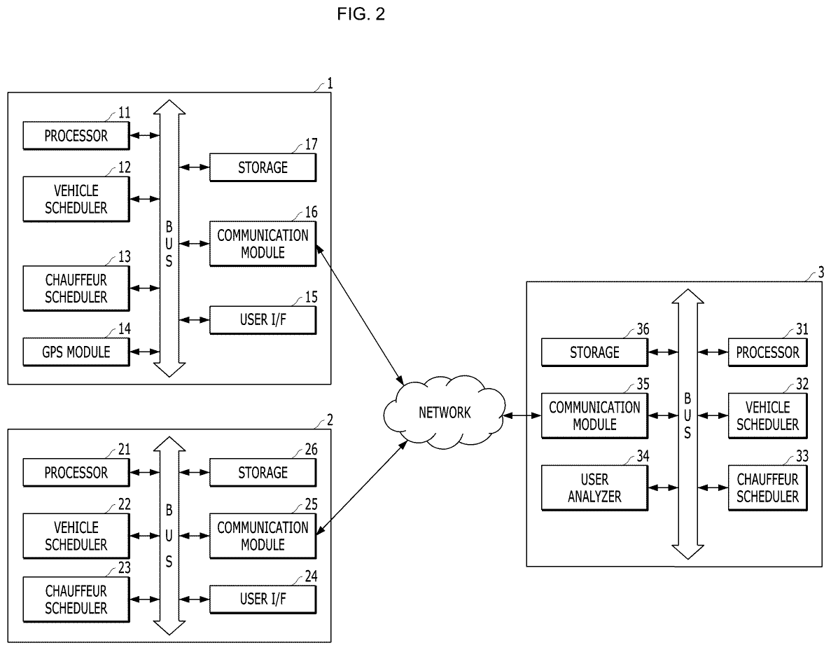

FIG. 2 is a configuration diagram of the user terminal 1, the chauffeur terminal 2, and the server 3 illustrated in FIG. 2. The user terminal 1 may include a processor 11, a vehicle scheduler 12, a chauffeur scheduler 13, a global positioning system (GPS) module 14, a user interface 15, a communication module 16, and a storage 17. The processor 11 processes a general task of a mobile terminal, such as a smartphone. The vehicle scheduler 12 processes tasks related to vehicle scheduling from a viewpoint of the user terminal 1. The chauffeur scheduler 13 processes tasks related to chauffeur scheduling from a viewpoint of the user terminal 1. The vehicle scheduler 12 and the chauffeur scheduler 12 may also be implemented as separate dedicated processors different from the processor 11 or may also be implemented by executing a computer program of the processor 11. A vehicle scheduler and a chauffeur scheduler of each of the chauffeur terminal 2 and the server 3 to be described below may also be implemented similarly.

The GPS module 14 measures global positioning system (GPS) measures as the current position coordinates of the user terminal 1. The user interface 15 receives an input of certain information, commands, and so on from a user and displays various types of information, such as text, image, video, and audio, to the user. The user interface 15 may be generally implemented by a combination of a display panel and a touch screen panel. A user interface of the chauffeur terminal 2 to be described below may also be implemented similarly thereto. The communication module 16 supports a wireless communication function so as to communicate with the server 3 through a wide area network, such as the Internet, by being wirelessly connected to a long-term evolution (LTE) base station or a Wi-Fi repeater. The storage 17 stores chauffeur service applications for users and data used by the chauffeur service applications.

Referring to FIG. 2, the chauffeur terminal 2 includes a processor 21, a vehicle scheduler 22, a chauffeur scheduler 23, a user interface 24, a communication module 25, and a storage 26. The processor 21 processes a general task of a mobile terminal, such as a smartphone. The vehicle scheduler 22 processes a task related to vehicle scheduling from the viewpoint of the chauffeur terminal 2. The chauffeur scheduler 23 processes a task related to chauffeur scheduling from the viewpoint of the chauffeur terminal 2. The user interface 24 receives an input of certain information, commands, and so on from a chauffeur and displays various types of information, such as text, image, video, and audio, to the chauffeur. The communication module 25 supports a wireless communication function so as to communicate with the server 3 through a wide area network, such as the Internet, by being wirelessly connected to an LTE base station or a Wi-Fi repeater. The storage 26 stores chauffeur service applications for chauffeurs and data used by the chauffeur service applications.

Referring to FIG. 2, the server 3 includes a processor 31, a vehicle scheduler 32, a chauffeur scheduler 33, a user analyzer 34, a communication module 35, and a storage 36. The processor 31 processes a general task of a large computer. The vehicle scheduler 32 processes a task related to vehicle scheduling from the viewpoint of the server 3. The chauffeur scheduler 33 processes a task related to chauffeur scheduling from the viewpoint of the server 3. The communication module 35 supports a wired communication function so as to communicate with the user terminal 1 or the chauffeur terminal 2 through a wide area network, such as the Internet. The storage 36 stores information on a plurality of vehicles and information on a plurality of chauffeurs.

The user terminal 1, the chauffeur terminal 2, and the server 3 may each further include additional components in addition to the components described above. For example, the user terminal 1, the chauffeur terminal 2, and the server 3 may each include a bus for transmitting data between various components as illustrated in FIG. 2 and may include a power module that supplies a drive power to each component although not illustrated in FIG. 2. As such, descriptions of components that are obvious to those skilled in the art to which the present disclosure pertains are omitted so as not to obscure the features of the present embodiments.

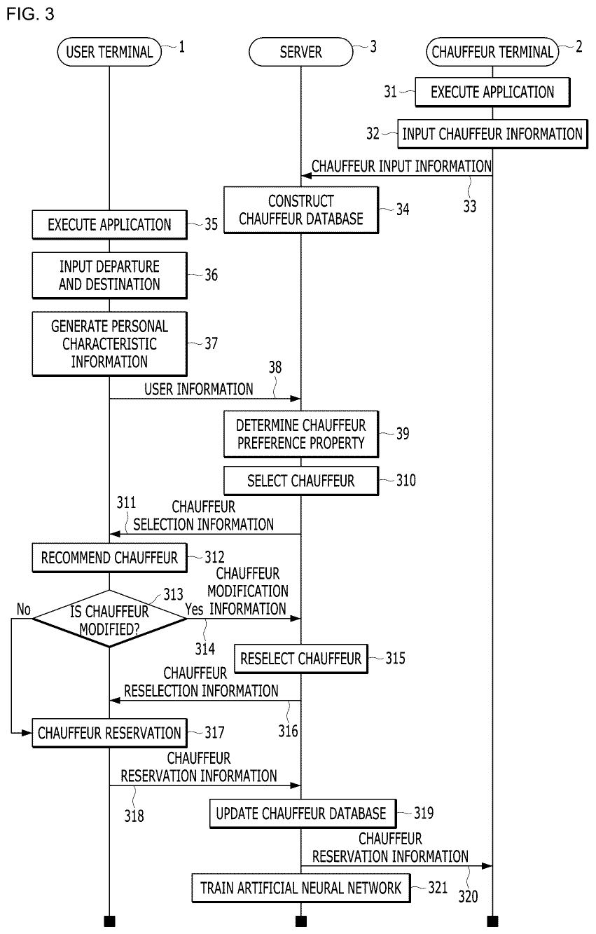

FIG. 3 is a flowchart of a chauffeur recommendation service method according to an embodiment of the present disclosure. Referring to FIG. 3, the chauffeur recommendation service method according to the present embodiment includes steps performed in time series by the user terminal 1, the chauffeur terminal 2, and the server 3 illustrated in FIG. 2. A chauffeur service according to the present embodiment refers to a service that provides a combination of any one vehicle and any one chauffeur among a plurality of vehicles and a plurality of chauffeurs to a user. The features of the present embodiment include an algorithm for recommending at least one chauffeur suitable for a user among the plurality of chauffeurs. Hereinafter, each of the user terminal 1, the chauffeur terminal 2, and the server 3 will be described in detail in the process of describing the chauffeur recommendation service method according to an embodiment of the present disclosure.

A chauffeur recommendation service system according to an embodiment of the present disclosure includes the user terminal 1, the chauffeur terminal 2, and the server 3 as described below. In order not to obscure the features of the present embodiment, a chauffeur recommendation service of the chauffeur services according to the present embodiments will be mainly described below, and detailed descriptions of the chauffeur services not related to the features of the present embodiment, such as vehicle scheduling, are omitted.

In step 31, the processor 21 of the chauffeur terminal 2 executes a chauffeur service application when receiving an input of a command for executing the chauffeur service application displayed thereon from a user through the user interface 24 and is connected to the server 3 that relays the present user terminal 1 and the chauffeur terminal 2 through the communication module 25. Before that, a chauffeur service application for a chauffeur is downloaded from the server 3 to the chauffeur terminal 2. A chauffeur corresponding to a user of the chauffeur terminal 2 has to subscribe to the chauffeur service in order to use the chauffeur service according to the present embodiment. Descriptions of the chauffeur's subscription to the chauffeur service, generation of the chauffeur's identification (ID) and password, and a login procedure are omitted.

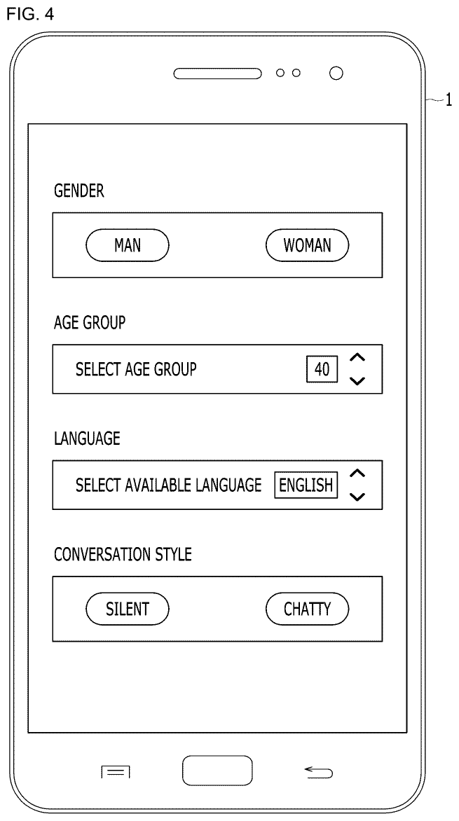

In step 32, the user interface 24 of the chauffeur terminal 2 displays a graphical user interface (GUI) screen for receiving information on each of a plurality of chauffeur classification items for classifying a plurality of chauffeurs for each of a plurality of items and receives an input of information on each of the plurality of chauffeur classification items from a chauffeur. FIG. 4 illustrates an example of the GUI screen for receiving information on each of the plurality of chauffeur classification items. A chauffeur corresponding to a user of the chauffeur terminal 2 may input the information on each of the plurality of chauffeur classification items by using an input method, such as a screen touch, while viewing the GUI screen illustrated in FIG. 4.

The plurality of chauffeur classification items according to the present embodiment include a gender item for classifying a plurality of chauffeurs according to each chauffeur's gender, an age group item for classifying the plurality of chauffeurs according to each chauffeur's age group, a language item for classifying the plurality of chauffeurs according to each chauffeur's available language, and a conversation style item for classifying the plurality of chauffeurs according to each chauffeur's conversation style. A plurality of chauffeur classification items may not include some of the above-described items and may further include other items in addition to the above-described items.

A chauffeur may input information on the gender item by selecting either male or female in the gender item on the GUI screen illustrated in FIG. 4. Subsequently, the chauffeur may input information on the age group item by selecting any one of 20s, 30s, 40s, 50s, and 60s from the age group item. Subsequently, the chauffeur may input information on the language item by selecting any one of English, Korean, Chinese, Japanese, and Spanish as the language item. Subsequently, the chauffeur may input information on the conversation style item by selecting any one of a silent style and a chatty style of the conversation style item.

In step 33, the chauffeur scheduler 23 of the chauffeur terminal 2 transmits information on each of the plurality of chauffeur classification items, which are input from a chauffeur through the user interface 24 in step 32, to the server 3 through the communication module 25. Subsequently, the chauffeur scheduler 33 of the server 3 receives information on each of the plurality of chauffeur classification items from the chauffeur terminal 2 through the communication module 35.

In step 34, the chauffeur scheduler 33 of the server 3 maps the information on each of the plurality of chauffeur classification items received in step 33 to the ID of a chauffeur corresponding to a user of the chauffeur terminal 2 and stores the mapped ID in the storage 36. Step 31 to step 33 are performed for all terminals of chauffeurs subscribed in the chauffeur service according to the present embodiment, in addition to the chauffeur terminal 2 illustrated in FIG. 1. The chauffeur scheduler 33 may build a chauffeur database by mapping information on each of the plurality of chauffeur classification items to IDs of all chauffeurs subscribed in the chauffeur service and storing the mapped IDs.

For example, two codes of male “11” and female “12” may be assigned to the gender item among the chauffeur classification items. Five codes of 20s “21”, 30s “22”, 40s “23”, 50s “24”, and 60s “25” may be assigned to the age group item. Five codes of English “31”, Korean “32”, Chinese “33”, Japanese “34”, and Spanish “35” may be assigned to the language item. Two codes of a silent style “41” and a chatty style “42” may be assigned to the conversation style item. When the ID of a chauffeur corresponding to a user of the chauffeur terminal 2 is “Jackson” and the chauffeur selects and inputs a male, 40s, English, and silent style, “Jackson”, “11”, “23”, “31”, and “41” are mapped to each other and stored in the storage 36 of the server 3.

In this way, a chauffeur database is constructed in a structure in which one code is mapped to the ID of each of the plurality of chauffeurs subscribed in a chauffeur service for each of a plurality of chauffeur classification items and then be stored in the storage 36. The chauffeur database is constructed in a structure in which information on each chauffeur's reservation schedule is also mapped to each chauffeur's ID in addition to the codes of the plurality of chauffeur classification items and then be stored.

In step 35, when the processor 11 of the user terminal 1 receives an input of a command for a chauffeur service application for a user displayed in the user terminal 1 to be executed from a user through the user interface 15, the processor 11 executes the chauffeur service application and is connected to the server 3 that relays the user terminal 1 and the chauffeur terminal 2 through the communication module 25. Before that, the chauffeur service application is downloaded from the server 3 to the user terminal 1. In order to use a chauffeur service of the present embodiment, a user of the user terminal 1 has to be subscribed in the chauffeur service. Descriptions of a user's subscription to the chauffeur service, generation of a chauffeur's ID and password, and a login procedure are omitted.

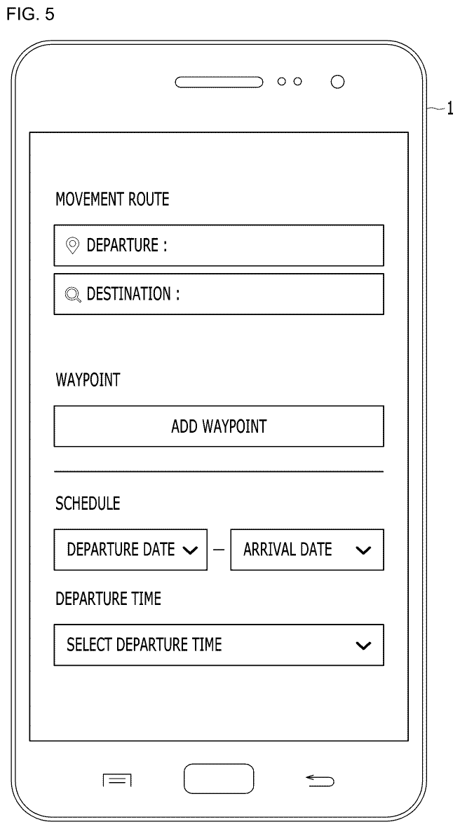

In step 36, the user interface 15 of the user terminal 1 displays a GUI screen for receiving an input of a departure and a destination of a route on which that a user wants to move, departure date and time from the departure, and an arrival date to the destination from a user (hereinafter, referred to as a “current user”) who currently wants to use the chauffeur service of the present embodiment and receives an input of the departure, the destination, the departure date, the departure time, and the arrival date from the current user as a current user's travel schedule information. FIG. 5 illustrates an example of the GUI screen for receiving a user's movement schedule information. The current user may input movement schedule information by using an input method, such as a screen touch, while viewing the GUI screen illustrated in FIG. 5. An address corresponding to coordinates of the current position of the user terminal 1 measured by the GPS module 14 may be displayed in a source field of the GUI screen. In this case, the current user may input the coordinates of the current position of the user terminal 1 by clicking the address displayed in a departure field.

In step 37, the chauffeur scheduler 13 of the user terminal 1 generates personal characteristic information of the current user by monitoring an input process of the current user's departure and a destination in step 36 and modification of a chauffeur's chauffeur classification item previously recommended to the current user. A general example of the personal characteristic information of each user of the chauffeur service may include gender and age of each user. When the user of the chauffeur service is a woman, the woman generally tends to select a female chauffeur, and preferably a chauffeur of a similar age. Information on the gender and age may be obtained in a membership registration process of the chauffeur service, but it is not easy to obtain genders and ages of all users who use the chauffeur service according to a recent trend of reluctance to disclose personal information.

Accordingly, the personal characteristic information of each user according to the present embodiment includes time for each user to completely input a departure and a destination of a route on which each user wants to move on a GUI screen of a chauffeur service application, the number of modifications in the process in which each user inputs the departure and the destination, information of a country in which each user is located at the time of inputting the departure and the destination, and codes of at least one chauffeur item modified most recently by each user. The information of the country in which each user is located at the time of inputting the departure and the destination may be obtained from coordinates of a position of the user terminal 1 measured by the GPS module 14 at the time of inputting the departure and the destination. The personal characteristic information of each user may not include some of the above-described items or may further include other items in addition to the above-described items. For example, when a user has no experience of using the chauffeur service of the present embodiment, there is no code of the chauffeur classification item modified most recently by each user.

In this way, the chauffeur scheduler 13 generates information on time for a current user to completely input a departure and a destination, the number of modifications in the process in which the current user inputs the departure and the destination, and a country where the current user is located at the time of inputting the departure and the destination as the personal characteristic information of the current user by monitoring the process of inputting the departure and the destination of the current user in step 36, and reads codes of at least one chauffeur item modified most recently by the current user from the storage 17, and thereby, generating codes of at least one chauffeur item modified most recently by the current user. When a user modifies at least one code of the chauffeur classification item of a chauffeur previously recommended to a certain user, the modification history is stored in the user's terminal.

In step 38, the chauffeur scheduler 13 of the user terminal 1 transmits the movement schedule information input by the current user through the user interface 15 in step 36 and the personal characteristic information of the current user generated in step 37 to the server 3 through the communication module 16. Next, the chauffeur scheduler 33 of the server 3 receives the movement schedule information input by the current user and the personal characteristic information of the current user from the user terminal 1 through the communication module 35. When at least one waypoint is additionally input by the current user in step 36 in addition to the departure and the destination, the movement schedule information includes information on the waypoint. In this case, the chauffeur scheduler 33 of the server 3 additionally receives the information on the waypoint in addition to the departure and the destination.

The current user may input the departure, the destination, and the waypoint similarly to filling a departure address, a destination address, and a waypoint address in a departure field, a destination field, and a waypoint field of the GUI screen. In this case, the information on each of the departure, the destination, and the waypoint transmitted from the user terminal 1 to the server 3 may also be an address of each of the departure, the destination, and the waypoint, and may also be an identification code for each of the departure, the destination, and the waypoint corresponding to each address of the departure, the destination, and the waypoint. The current user may input a departure date, an arrival date, and a departure time by selecting the departure date, the arrival date, and the departure time from a departure date field, an arrival date field, and a departure time field. The chauffeur service of the present embodiment may include a long-distance movement service for several days in an overseas travel in addition to a short-distance movement service for one day.

In step 39, the user analyzer 34 of the server 3 determines a chauffeur preference property of the current user from a chauffeur preference property of each of a plurality of existing users by determining any one of a plurality of codes assigned to each of a plurality of chauffeur classification items based on a correlation between the plurality of existing users having a history of using the chauffeur service and the current user. In more detail, the user analyzer 34 determines any one of a plurality of codes assigned to each of the plurality of chauffeur classification items based on a correlation between the personal characteristic information of each of the plurality of existing users and the personal characteristic information of the current user received by the chauffeur scheduler 33 in step 38, thereby determining the chauffeur preference property of the current user from the chauffeur preference property of each of the plurality of existing users. Hereinafter, the existing users and the current user of the chauffeur service will be collectively referred to as users of the chauffeur service.

According to the personal characteristic information of each user described above, the user analyzer 34 determines the chauffeur preference property of the current user from the chauffeur preference property of each of the plurality of existing users based on time required to completely input the departure and the destination of the route on which each of the plurality of existing users and the current user wants to move, the number of modifications in the process in which each user inputs the departure and the destination, information of a country in which each user is located at the time of inputting the departure and the destination, and a correlation between the plurality of existing users and the current user corresponding to similarity of codes of at least one chauffeur classification item modified most recently by each user.

In order to verify whether a user's chauffeur preference property may be derived from a user's personal characteristic information, about one hundred testees belonging to various genders, various age groups, and various occupational groups were recruited. As a result of testing an input of a departure and a destination for the one hundred testes and conducting a survey, the times required to completely input the departure and the destination were different from each other depending on individual characteristics of each testee. For example, the more meticulous the personality of each testee, the longer the time required to completely input the departure and the destination, and the testees generally have a property of preferring a quiet atmosphere with few people. As personality of each testee is more distracting, the number of modifications in the process of inputting the departure and the destination tend to increase, and generally, the testees tend to prefer a noisy atmosphere with many people.

Each user generally uses a language of the country in which each user resides and tends to prefer a chauffeur who may use the language of the country. In the process of preparing for a domestic travel or an overseas travel, each user is usually located in a certain region of the country in which each user resides and inputs a departure and a destination. Accordingly, each user's preferred language may be estimated from information of the country in which each user is located at a point in time when each user inputs the departure point and the destination. The information of the country may be the name of the country or may also be an identification code of the country corresponding to the name. When a user modifies at least one of codes of a plurality of chauffeur classification items of a recommended chauffeur according to the present embodiment, it may be estimated that the user has a specific property different from the chauffeur preference property of general user, or there is an error in predicting chauffeur preference property for some users.

Determination of the chauffeur preference property of the current user based on a correlation between the plurality of existing users and the current user may not be formulated by using any equation as described above. The present embodiment uses an artificial neural network to determine the chauffeur preference property of the current user based on a correlation between a plurality of existing users and the current user.

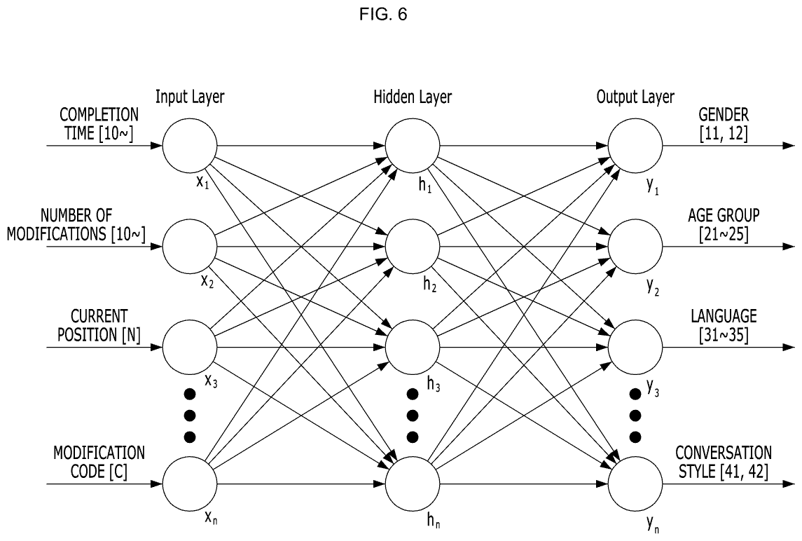

FIG. 6 is a diagram illustrating an example of training of an artificial neural network used by the user analyzer 34 illustrated in FIG. 2. The artificial neural network is trained by inputting personal characteristic information of each of a plurality of existing users to an input layer of the artificial neural network and inputting data representing a chauffeur preference property of each of the plurality of existing users to an output layer of the artificial neural network. According to the example illustrated in FIG. 6, time for any existing user to completely input a departure and a destination, the number of modifications in the process of inputting the departure and the destination by the existing user, information of a country where the existing user is located at the time of inputting the departure and the destination, and codes of at least one chauffeur classification item modified most recently by the existing user are input to the input layer of the artificial neural network.

For example, when a minimum value of the time required for a user to completely input the departure and the destination is “10 seconds”, a value of 10 or more is input in seconds to a neuron “x₁” of the input layer of the artificial neural network. When a minimum value of the number of modifications in the process of inputting the departure and the destination by the user is “0”, a value of 0 or more may be input in seconds to a neuron “x₂” of the input layer of the artificial neural network. An identification code “N” of a country where the existing user is located at the time of inputting the departure and the destination may be input to a neuron “x₃” of the input layer of the artificial neural network. A code “C” of at least one chauffeur classification item modified most recently by the existing user may be input to a neuron “x₄” of the input layer of the artificial neural network. Here, “N” and “C” are any one numeric value.

In FIG. 6, the number of neurons of the input layer of the artificial neural network is represented as n in consideration of a possibility of variation in each user's personal characteristic information. In the example described above, the neuron “xₙ” is the neuron “x₄”. When a part of each user's personal characteristic information is insufficient, no value is input to the corresponding neuron. Although FIG. 6 illustrates that a hidden layer is composed of one layer for the sake of simplicity of drawing, the hidden layer has several layers in general.

Any one of a plurality of codes [11 and 12] of the gender item, any one of a plurality of codes [21 to 25] of the age group item, any one of a plurality of codes [31 to 35] of the language item, and any one of a plurality of codes [41 and 42] of the conversation style item are input to the output layer of the artificial neural network as data representing the chauffeur preference property of the existing user. This input process is repeated for all existing users who have used the chauffeur service. As the number of inputs of the existing user data to the artificial neural network increases, prediction accuracy of the chauffeur preference property of the current user using the artificial neural network is improved.

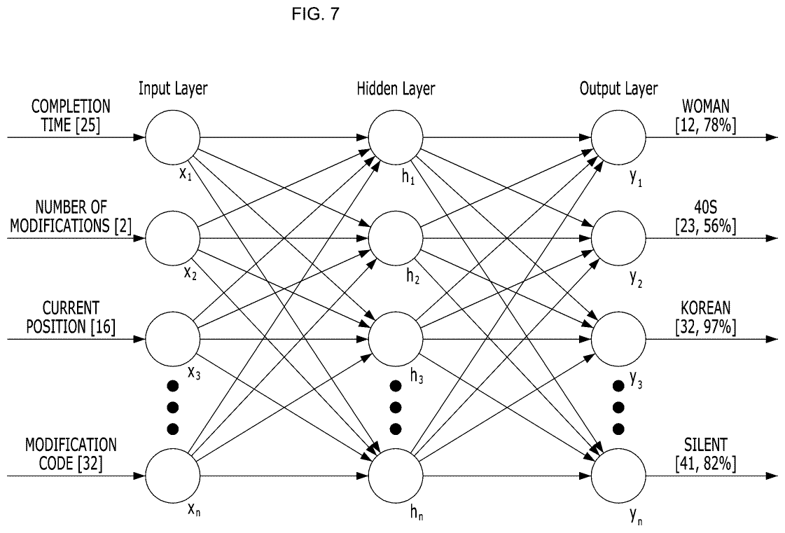

FIG. 7 is a diagram illustrating an example of using the artificial neural network trained according to the example illustrated in FIG. 6. Referring to FIG. 7, the user analyzer 34 obtains data indicating the chauffeur preference property of the current user from the artificial neural network by inputting the personal characteristic information of the current user to the input layer of the artificial neural network trained by using the personal characteristic information of each of the plurality of existing users and data representing the chauffeur preference property of each of the plurality of existing users according to the example illustrated in FIG. 6, and determines the chauffeur preference property indicated by the obtained data as the chauffeur preference property of the current user. The user analyzer 34 obtains any one of a plurality of codes assigned to each of the plurality of chauffeur classification items as the data representing the chauffeur preference property of the current user from the output layer of the artificial neural network.

When the personal characteristic information of the current user is input to the input layer of the artificial neural network, any one of a plurality of codes of the gender item, any one of a plurality of codes of the age group item, any one of a plurality of codes of the language item, and any one of a plurality of codes of the conversation style item are output from the output layer of the artificial neural network as the data indicating the chauffeur preference property of the current user. Accordingly, the user analyzer 34 obtains a plurality of codes for a plurality of chauffeur classification items from the output layer of the artificial neural network as the data indicating the chauffeur preference property of the current user.

According to the example illustrated in FIG. 7, time “25” required for the current user to completely input a departure and a destination is input to the neuron “x₁” of the input layer of the artificial neural network as personal characteristic information of the current user, the number of modifications “2” in the process of inputting the departure and the destination by the current user is input to the neuron “x₂”, information “16” of a country where the current user is located at the time of inputting the departure and the destination are input to the neuron “x₃”, and a code “32” of at least one chauffeur classification item modified most recently by the current user is input to the neuron “x₄”.

“12” and “78” are output from a neuron “y₁” of the output layer of the artificial neural network. “12” indicates a female, and “78” indicates a probability that the current user prefers a female. “23” and “56” are output from a neuron “y₂” of the output layer of the artificial neural network. “23” indicates 40s, and “56” indicates a probability that the current user prefers 40s. “32” and “97” are output from a neuron “ye” of the output layer of the artificial neural network. “32” indicates Korean, and “97” indicates a probability that the current user prefers Korean. “41” and “82” are output from a neuron “y₄” of the output layer of the artificial neural network. “41” indicates a silent style, and “82” indicates a probability that the current user prefers a reticent style.

In step 310, the chauffeur scheduler 33 of the server 3 selects at least one chauffeur matching the chauffeur preference property of the current user determined by the user analyzer 34 in step 38 from among a plurality of chauffeur available for the departure and the destination input by the current user in step 36, that is, the departure and the destination of the movement schedule information received by the chauffeur scheduler 33 in step 38. The chauffeur scheduler 33 searches for a plurality of chauffeur available to the departure and the destination input by the current user from among a plurality of chauffeurs whose information is recorded in a chauffeur database of the storage 36 of the server 3, and selects at least one chauffeur matching the chauffeur preference property of the current user from among the plurality of chauffeurs searched as described above. The plurality of chauffeurs available for the departure and the destination indicates a plurality of chauffeurs who may drive a vehicle from the departure to the destination and do not have reservations for other chauffeur services from a departure date of the departure to an arrival date of the destination.

More specifically, the chauffeur scheduler 33 selects at least one chauffeur matching the chauffeur preference property of the current user determined in step 38 by selecting at least one chauffeur from among the plurality of chauffeurs available for the departure and the destination input by the current user in the order of increasing number of matches between a plurality of codes determined for the plurality of chauffeur classification items in step 39 and a plurality of codes mapped to the respective IDs of the plurality of chauffeurs. That is, the chauffeur scheduler 33 selects at least one chauffeur matching the chauffeur preference property of the current user determined in step 38 by selecting at least one chauffeur from among the plurality of chauffeurs available for the departure and the destination input by the current user in the order of increasing number of matches between a plurality of codes obtained for the plurality of chauffeur classification items from an artificial neural network in step 39 and the plurality of codes mapped to the respective IDs of the plurality of chauffeurs.

In step 39, there may be multiple chauffeurs having the same number of matches between the plurality of codes determined for the plurality of chauffeur classification items in step 39 and the plurality of codes mapped to the respective IDs of the plurality of chauffeurs, and there may be a case in which some of the chauffeurs having the same number has to be selected due to the limit of the number of recommendable chauffeurs according to the present embodiment.

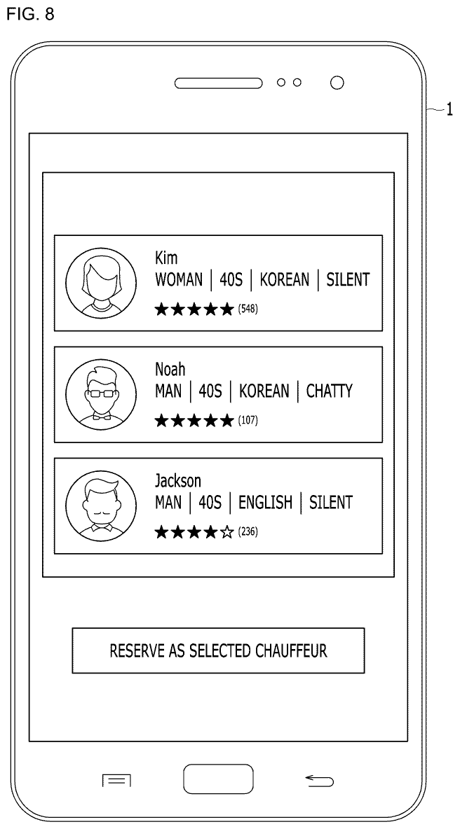

In step 310, the chauffeur scheduler 33 may select some of the plurality of chauffeurs in the order of increasing weight of each chauffeur from among a plurality of chauffeurs having the same number of matches between the plurality of codes determined for the plurality of chauffeur classification items and the plurality of codes mapped to respective IDs of the plurality of chauffeur. The chauffeur scheduler 33 may determine weights of the respective chauffeurs based on scores of the respective chauffeurs evaluated by a plurality of existing users. As illustrated in the example of FIG. 8, the existing user may evaluate a chauffeur provided through a chauffeur service. For example, the chauffeur scheduler 33 may determine weights of the respective chauffeurs in proportion to the sum of evaluation scores of the respective chauffeurs by the plurality of existing users.

Otherwise, in step 39, the chauffeur scheduler 33 may obtain any one of a plurality of codes assigned to each of the plurality of chauffeur classification items from an artificial neural network and simultaneously obtain an occurrence probability value of each of the plurality of codes obtained for the plurality of chauffeur classification items, and in step 310, may select some of the plurality of codes mapped to the IDs of the respective chauffeurs in the order of increasing occurrence probability values of at least one code obtained from the artificial neural network in step 39 from among a plurality of chauffeurs having the same number of matches between a plurality of codes obtained for the plurality of chauffeur classification items from the artificial neural network and the plurality of codes mapped to respective IDs of the plurality of chauffeurs.

In the example illustrated in FIGS. 7 and 8, the sum of the occurrence probability of “56%” of the code “23” obtained from the artificial neural network among the plurality of codes “11”, “23”, “31”, and “41” mapped to the chauffeur “Jackson” in step 39 and the occurrence probability of “82%” of the code “41” obtained therefrom is “138”. When the plurality of codes “12”, “23”, “31”, and “42” are mapped to the chauffeur “Jane”, the sum of the occurrence probability of “78%” of the code “12” and the occurrence probability of “56%” of the code “23” is “134”. In this case, both the chauffeur “Jackson” and the chauffeur “Jane” each have two matching codes among the plurality of codes obtained from the artificial neural network, but the chauffeur “Jackson” is greater in the sum of the occurrence probabilities of the two matching codes. Accordingly, the chauffeur “Jackson” may be selected. In this way, when a chauffeur may not be selected only with the chauffeur preference property of the current user, an evaluation scores of each chauffeur may be used, or an occurrence probability of each of a plurality of codes may be used.

In step 311, the chauffeur scheduler 33 of the server 3 transmits information on at least one chauffeur selected in step 310 to the user terminal 1 through the communication module 35. Subsequently, the chauffeur scheduler 13 of the user terminal 1 receives the information on at least one chauffeur selected in step 310 from the server 3 through the communication module 16. The information on at least one chauffeur selected in step 310 includes a chauffeur ID for each chauffeur selected in step 310 and codes of a plurality of chauffeur classification items. When the chauffeur in the example illustrated in FIG. 7 is selected, an ID “Kim” of the chauffeur and “12”, “23”, “31”, and “41” that are codes of the plurality of chauffeur classification items of the chauffeur are transmitted to the user terminal 1.

In step 312, the chauffeur scheduler 13 of the user terminal 1 recommends, to the current user, at least one chauffeur indicated by the information received in step 311, that is, at least one chauffeur selected by the server 3 in step 310. The chauffeur scheduler 13 recommends at least one chauffeur selected in step 310 by allowing the user interface to display the recommendation of at least one chauffeur selected in step 310 to the current user. FIG. 8 illustrates an example of a GUI screen for recommending at least one chauffeur selected in step 310.

In step 313, the chauffeur scheduler 13 checks whether there is modification by the current user input through the user interface 15 in the codes of a plurality of chauffeur classification items of at least one chauffeur recommended in step 312. As a result of the check, when there is modification of codes of the plurality of chauffeur classification items of the chauffeur, the processing proceeds to step 314. Otherwise, the processing proceeds to step 317. For example, the current user clicks any one of three sections indicating the three chauffeurs illustrated in FIG. 8 and then clicks once or multiple times at least one of four chauffeur classification items in the section, and thereby, the codes of the plurality of chauffeur classification items of the chauffeur displayed in the section may be modified. When a user clicks a display for a code of a certain chauffeur classification item, for example, “30s”, the display is changed to “40s”. When “40s” are clicked, the display is changed to “50s”.

In step 314, the chauffeur scheduler 13 of the user terminal 1 transmits modification information on codes of a plurality of chauffeur classification items of a certain chauffeur checked in step 313 to the server 3 through the communication module 16. Subsequently, the chauffeur scheduler 33 of the server 3 receives, from the user terminal 1 through the communication module 35, the modification information on the codes of the plurality of chauffeur classification items of the certain chauffeur identified in step 313. The modification information on the codes of the plurality of chauffeur classification items of the certain chauffeur identified in step 313 may include an ID of the chauffeur and codes modified by the current user.

In step 315, the chauffeur scheduler 33 of the server 3 reselects at least one chauffeur matching the code modification information received in step 314, that is, the modification information on the codes of the plurality of chauffeur classification items of the certain chauffeur identified in step 313 from among a plurality of chauffeurs available for the departure and the destination input by the current user in step 36. For example, when the code “12” of the codes “12”, “23”, “31”, and “41” of a chauffeur “Kim” is modified to “11”, the chauffeur scheduler 33 reselects at least one chauffeur matching the codes “11”, “23”, “31”, and “41” from among a plurality of chauffeurs available for the departure and the destination input by the current user. Since the chauffeur reselection process is the same as the chauffeur selection process described above, more detailed descriptions thereof are omitted.

In step 316, the chauffeur scheduler 33 of the server 3 transmits information on at least one chauffeur reselected in step 315 to the user terminal 1 through the communication module 35. Subsequently, the chauffeur scheduler 13 of the user terminal 1 receives the information on at least one chauffeur reselected in step 315 from the server 3 through the communication module 16. The information on the reselected chauffeur in step 315 includes a chauffeur ID for each chauffeur reselected in step 315 and codes of a plurality of chauffeur classification items. Subsequently, the user interface 15 of the user terminal 1 displays the information on at least one chauffeur reselected in step 315.

When there is no chauffeur matching the modification information on the codes of the plurality of chauffeur classification items of the certain chauffeur checked in step 313, the chauffeur scheduler 33 transmits a message indicating that there is no chauffeur matching the modification of the current user instead of the chauffeur reselection information, to the user terminal 1. In this case, the user interface 15 of the user terminal 1 continuously displays the information on at least one chauffeur recommended in step 312 together with the message indicating that there is no chauffeur matching the modification of the current user instead of the information on at least one chauffeur reselected in step 315.

In step 317, the user interface 15 of the user terminal 1 receives an input of reservation for any one chauffeur from the current user among at least one chauffeur recommended in step 312 or at least one chauffeur indicated by the chauffeur information received in step 316. The at least one chauffeur indicated by the chauffeur information received in step 316 refers to the at least one chauffeur reselected in step 315. For example, the current user may input the reservation for at least one chauffeur by clicking any one of the three sections indicating the three chauffeurs illustrated in FIG. 8 and then clicking a button “Reservation” at a lower portion of the screen illustrated in FIG. 8.

In step 318, the chauffeur scheduler 13 of the user terminal 1 transmits the reservation information on any one chauffeur input by the current user through the user interface 15 in step 317 to the server 3 through the communication module 16. Subsequently, the chauffeur scheduler 33 of the server 3 receives the chauffeur reservation information input by the current user from the user terminal 1 through the communication module 35. The chauffeur reservation information input by the current user may include an ID of the current user and an ID of any one chauffeur.

In step 319, the chauffeur scheduler 33 of the server 3 updates a chauffeur database by mapping the movement schedule information received in step 38 to the chauffeur ID indicated by the chauffeur reservation information received in step 318 among a plurality of chauffeur IDs recorded in a chauffeur database and records the mapping result. As described above, the chauffeur database is updated whenever a reservation event for a certain chauffeur occurs, and thus, it is possible to search for a chauffeurs available for the departure and the destination in step 310.

In step 320, the chauffeur scheduler 33 of the server 3 transmits the chauffeur reservation information received in step 318 and the movement schedule information received in step 38 to the chauffeur terminal 2 through the communication module 35. Subsequently, the chauffeur scheduler 23 of the chauffeur terminal 2 receives the chauffeur reservation information and the movement schedule information of the current user from the server 3 through the communication module 25. Subsequently, the user interface 24 of the chauffeur terminal 2 displays a chauffeur ID and a user ID indicated by the chauffeur reservation information of the current user and displays a departure, a destination, a departure date, an arrival date, and departure time indicated by the movement schedule information of the current user. A chauffeur corresponding to a user of the chauffeur terminal 2 may check a user who made a reservation for himself and a movement schedule of the user therefrom.

In step 321, the user analyzer 34 of the server 3 trains an artificial neural network by inputting personal characteristic information of the current user received in step 38 to an input layer of the artificial neural network and by inputting codes of a plurality of chauffeur classification items mapped to the ID indicated by the chauffeur reservation information received in step 318 to an output layer of the artificial neural network. When modification information on the codes of the plurality of chauffeur classification items of a chauffeur is received in step 314, the codes modified by the current user are input to the input layer of the artificial neural network. As such, in step 321, the current user becomes an existing user, and training of the artificial neural network is performed. Since the training of the artificial neural network is performed whenever a user makes a reservation for a chauffeur by using a chauffeur service of the present embodiment, accuracy of chauffeur recommendation is gradually improved as the number of users using the chauffeur service increases.

Meanwhile, a chauffeur recommendation service method described above may be implemented by a program that may be executed by a processor of a computer, and may be performed by a computer that records the program on a computer-readable recording medium and executes the program. The computer includes any type of computers capable of executing a program, such as a desktop computer, a notebook computer, a smartphone, and an embedded type computer. In addition, a structure of data used in the embodiment of the present disclosure described above may be recorded in the computer-readable recording medium through various means. The computer-readable recording medium includes storages, such as a random access memory (RAM), a read only memory (ROM), a magnetic storage medium (for example, a floppy disk, a hard disk, or so on), and an optically readable medium (for example, a compact disk (CD)-ROM, digital video (versatile) disk (DVD), or so on).

A chauffeur preference property of a current user is determined based on a correlation between a plurality of existing users with a history of using a chauffeur service and the current user, and at least one chauffeur matching the chauffeur preference property of the current user is selected and recommended among a plurality of chauffeurs, and accordingly, a user may use a chauffeur service provided by a chauffeur matching his/her personal property. That is, a user may move from a departure to a destination by using a vehicle driven by a chauffeur matching to his/her personal property, and accordingly, user satisfaction on a chauffeur service may be improved.

In particular, a chauffeur matching a user's personal property among various chauffeurs of the chauffeur service may be accurately selected and recommended by determining a chauffeur preference property of the current user from the chauffeur preference properties of a plurality of existing users based on a correlation between personal characteristic information of each of the plurality of existing users and personal characteristic information of the current user. By obtaining data indicating a chauffeur preference property of a user by using an artificial neural network, accuracy of chauffeur recommendation may be further improved as the number of users using the chauffeur service increases. The present disclosure is not limited to the effects described above, and other effects may be derived from the following descriptions.

As described above, preferred embodiments of the present disclosure are provided. Those skilled in the art to which the present disclosure pertains will understand that the present disclosure may be implemented in a modified type without departing from the essential characteristics of the present disclosure. Therefore, the disclosed embodiments have to be considered in an illustrative sense rather than a restrictive sense. The scope of the present disclosure is indicated in the claims rather than the above description, and all differences within the scope equivalent thereto should be construed as being included in the present disclosure.

What is claimed is:

1. A method for a chauffeur recommendation service, the method comprising:
receiving, from a current user who wants to use a chauffeur service, an input of a departure and a destination of a route for the current user to move;
determining a chauffeur preference property of the current user based on a correlation between a plurality of existing users with a history of using the chauffeur service and the current user;
selecting at least one chauffeur matching the determined chauffeur preference property of the current user from among a plurality of chauffeurs available for the input departure and the input destination; and
recommending the selected at least one chauffeur to the current user.

2. The method of claim 1, wherein, in the determining of the chauffeur preference property of the current user, the chauffeur preference property of the current user is determined from a chauffeur preference property of each of the plurality of existing users based on a correlation between personal characteristic information of each of the plurality of existing users and personal characteristic information of the current user.

3. The method of claim 1, wherein
the personal characteristic information includes time required to completely input a departure and a destination of a route on which each of a plurality of users including the plurality of existing users and the current user wants to move, and a number of modifications during the inputting of the departure and the destination by each of the plurality of users, and
in the determining of the chauffeur preference property of the current user, the chauffeur preference property of the current user is determined based on a correlation between the plurality of existing users and the current user corresponding to similarity of the number of modifications during the inputting and the time required to completely input the departure and the destination between the plurality of existing users and the current user.

4. The method of claim 1, wherein
the personal characteristic information includes information on a country in which each user is located at a point in time when a departure and a destination to which a plurality of users including the plurality of existing users and the current user want to move are input, and
in the determining of the chauffeur preference property of the current user, the chauffeur preference property of the current user is determined based on a correlation between the plurality of existing users and the current user corresponding to similarity of the information of the country where each user is located at the point in time when the departure and the destination are input between the plurality of existing users and the current user.

5. The method of claim 1, wherein, in the determining of the chauffeur preference property of the current user, the chauffeur preference property of the current user is determined by determining any one of a plurality of codes assigned to each of a plurality of chauffeur classification items for classifying the plurality of chauffeurs for each of a plurality of items based on a correlation between the plurality of existing users and the current user.

6. The method of claim 5, wherein
any one code is mapped for each of the plurality of chauffeur classification items to an ID of each of the plurality of chauffeur, and
in the selecting of the at least one chauffeur, at least one chauffeur matching the chauffeur preference property of the current user is selected by selecting at least one of the plurality of chauffeurs in an order of increasing number of matches between a plurality of codes determined for the plurality of chauffeur classification items and a plurality of codes mapped to IDs of the plurality of chauffeurs.

7. The method of claim 6, wherein, in the selecting of the at least one chauffeur, the at least one chauffeur is selected in an order of increasing weight of each chauffeur from among a plurality of chauffeurs having the same number of matches between the plurality of codes determined for the plurality of chauffeur classification items and a plurality of codes assigned to the plurality of chauffeurs.

8. The method of claim 7, wherein the weight of each chauffeur is determined based on a score of each chauffeur evaluated by the plurality of existing users.

9. The method of claim 5, wherein the plurality of chauffeur classification items include at least two items among a gender item for classifying the plurality of chauffeurs according to a gender of each chauffeur, an age group item for classifying the plurality of chauffeurs according to an age group of the each chauffeur, a language item for classifying the plurality of chauffeurs according to an available language of the each chauffeur, and a conversation style item for classifying the plurality of chauffeurs according to a conversation style of the each chauffeur.

10. The method of claim 1, wherein, in determining of the chauffeur preference property of the current user, data indicating the chauffeur preference property of the current user is obtained from an artificial neural network by inputting personal characteristic information of the current user to the artificial neural network trained by using personal characteristic information of each of the plurality of existing users and data indicating a chauffeur preference property of each of the plurality of existing users, and the chauffeur preference property indicated by the obtained data is determined as the chauffeur preference property of the current user.

11. The method of claim 10, wherein
in the determining of the chauffeur preference property of the current user, any one of a plurality of codes assigned to each of a plurality of chauffeur classification items for classifying the plurality of chauffeurs for each of a plurality of items is obtained as the data indicating the chauffeur preference property of the current user from the artificial neural network, and
in the selecting of the at least one chauffeur, at least one chauffeur matching the determined chauffeur preference property of the current user is selected by selecting at least one of the plurality of chauffeurs in an order of increasing number of matches between a plurality of codes determined for the plurality of chauffeur classification items and a plurality of codes mapped to an ID of each of the plurality of chauffeurs.

12. The method of claim 11, wherein
in the determining of the chauffeur preference property of the current user, any one of the plurality of codes assigned to each of the plurality of chauffeur classification items for classifying the plurality of chauffeurs for each of the plurality of items is obtained and an occurrence probability value of each of the plurality of codes obtained for the plurality of chauffeur classification items simultaneously is obtained from then artificial neural network, and
in the selecting of the at least one chauffeur, the at least one chauffeur is selected in an order of increasing occurrence probability value of at least one code obtained from the artificial neural network for the plurality of codes mapped to the identification of each of the plurality of chauffeurs from among a plurality of chauffeurs having a same number of matches between a plurality of codes determined for the plurality of chauffeur classification items and the plurality of codes mapped to the ID of each of the plurality of chauffeurs.

13. A computer-readable recording medium in which a program for causing a computer to perform the method of claim 1 is recorded.

14. A system for a chauffeur recommendation service, the system comprising:
a user interface configured to receive, from a current user who wants to use a chauffeur service, input of a departure and a destination of a route for the current user to move;
a user analyzer configured to determine a chauffeur preference property of the current user based on a correlation between a plurality of existing users with a history of using the chauffeur service and the current user; and
a chauffeur scheduler configured to select at least one chauffeur matching the determined chauffeur preference property of the current user from among a plurality of chauffeurs available for the input departure and the input destination,
wherein the user interface displays recommendation of the selected at least one chauffeur to the current user.
